(19) United States
(12) Patent Application Publication
(10) Pub. No.: US 2016/0117307 A1
(43) Pub. Date: Apr. 28, 2016

(54) RECURSIVE EXTRACTION AND NARRATION OF NESTED TABLES

(71) Applicant: International Business Machines Corporation, Armonk, NY (US)

(72) Inventors: Ashish Mungi, Bangalore (IN); Purushothaman K. Narayanan, Bangalore (IN); Krishma Singla, Bangalore (IN); Bijo A. Thomas, Thiruvalla (IN)

(21) Appl. No.: 14/862,193

(22) Filed: Sep. 23, 2015

Related U.S. Application Data
(63) Continuation of application No. 14/525,597, filed on Oct. 28, 2014.

(51) Int. Cl. G06F 17/24

(52) U.S. Cl. CPC G06F 17/245; G06F 17/246

(57) ABSTRACT

Machine logic (for example, software) that performs the following steps: (i) providing a parent table including a set of nested table(s) so that the parent table has N levels of nestedness, with N being an integer greater than one; and (ii) extracting a first nested table at the Nth level of nestedness where N is an integer equal to or greater than one, with a value of one representing the root table, and with greater values representing tables nested within the root table; and (iii) replacing the first nested table with equivalent narration text. Software is agnostic with respect to parent tables having different structural patterns, different file formats, and/or different cell layouts.

### BACKGROUND OF THE INVENTION

The present invention relates generally to the field of data structured as tables, and more particularly to data structured as nested tables.

Unstructured data sources such as PDF (portable document format) documents, format documents, HTML (hypertext markup language) web pages, XML (extensible markup language) web pages, internet encyclopedias, etc., contain semi-structured data in the form of tables. Tables may have different structures, that is, structural patterns and may contain different types of structured and unstructured data such as unformatted text, formatted text (paragraphs, sentences, bulleted or numbered lists), photos and images, URLs (uniform resource locators), links, etc. Tables may also contain other tables, such that the inner table (child table) is completely contained within a cell of an outer table or parent table. Such tables are known as nested tables. Nested tables can go to any level of nesting, that is, an outer parent table may contain one or more child tables, and a child table may contain another child table (also called a “sub-child table”), and so on.

The number of generations of tables (parent, child, sub-child, etc.) is herein referred to as the level of nestedness. Herein, the top level table (or “root table”) is considered to be at the “first level of nestedness,” although it should be understood that the root table, at the first level of nestedness, is not nested inside of another table. Nested tables may occur in any “document format” such as HTML, PDF, format documents, spreadsheet documents, etc. For this reason, their detection and extraction may be format specific. “Table narration” is the conversion and description of the contents of a table (or a portion of a table) into free form natural language sentences and paragraphs, so that the resulting narration is equivalent to the original table contents and meaning.

### SUMMARY

According to an aspect of the present invention, there is a method, computer program product and/or system that performs the following steps (not necessarily in the following order): (i) providing a set of nested tables; (ii) extracting a first nested table, of the set of nested tables, at the Nth level of nestedness where N is an integer equal to or greater than one, with a value of one representing a root table of the set of nested tables, and with greater values for N representing tables nested within the root table; and (iii) replacing the first nested table with equivalent narration text.

### BRIEF DESCRIPTION OF THE DRAWINGS

FIG. 1 is a schematic view of a first embodiment of a system according to the present invention;

FIG. 2 is a flowchart showing a first embodiment of a method according to the present invention;

FIG. 3 is a schematic view of a machine logic (for example, software) portion of the first embodiment system;

FIG. 4 is a screenshot view generated by the first embodiment system;

FIG. 5 is a schematic view of a system according to the present invention;

FIG. 6 is a second screenshot view generated by an embodiment of the present invention;

FIG. 7A is a flowchart showing a first portion of a second embodiment of a method according to the present invention;

FIG. 7B is a flowchart showing a second portion of the second method;

FIGS. 8A to 8c are, respectively, third fourth and fifth screenshot views generated by an embodiment of the present invention;

FIG. 9 is a sixth screenshot view generated by an embodiment of the present invention;

FIG. 10 is a seventh screenshot view generated by an embodiment of the present invention;

FIG. 11 is an eighth screenshot view generated by an embodiment of the present invention; and

FIG. 12 is a flowchart showing a third embodiment of a method according to the present invention.

### DETAILED DESCRIPTION

Some embodiments of the present invention provide a generic way to do one of the following: (i) detect nested tables to any level of nesting; (ii) extract nested tables to any level of nesting; and (iii) narrate nested tables to any level of nesting. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

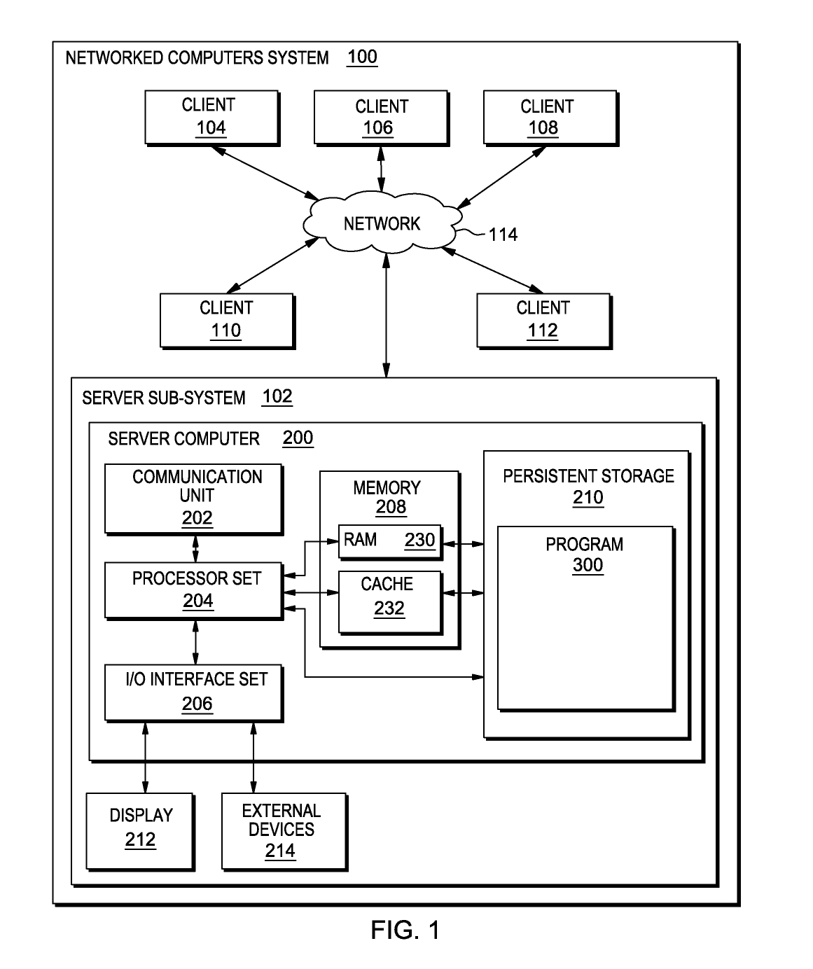

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply some, or all memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

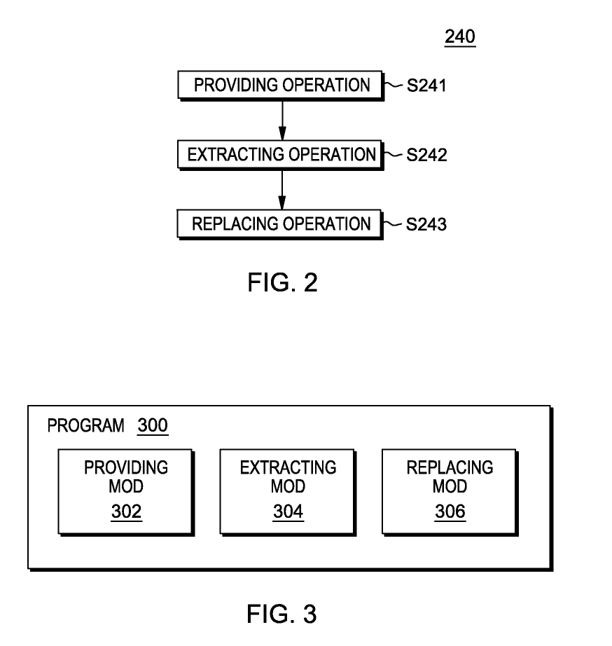

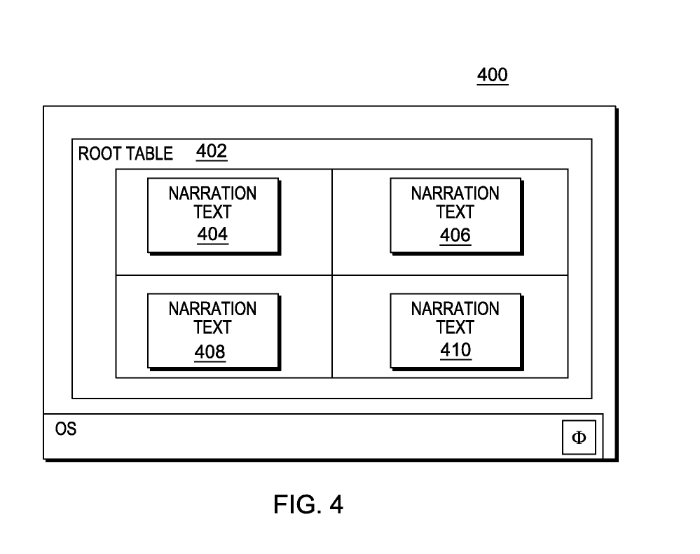

FIG. 2 shows flowchart 240 depicting a method according to the present invention. FIG. 3 shows program 300 for performing at least some of the method steps of flowchart 240. This method and associated software will now be discussed, over the course of the following paragraphs, with extensive reference to FIG. 2 (for the method step blocks) and FIG. 3 (for the software blocks).

Processing begins at step S241, where providing module (“mod”) 302 provides a set of nested tables (that is, a root table having one, or more, table(s) nested in the root table, with the tables being nested at one, or more, level(s) below the nestedness level of the root table).

Processing proceeds to step S242, where extracting mod 304 extracts a first nested table, of the set of nested tables. The first nested table, extracted at step S242, is at the Nth level of nestedness where N is an integer equal to or greater than one. The level of nestedness value, N, represents a nestedness level where: (i) N=1 is the level of nestedness of the root table itself (the root level); and (ii) greater values for N represent tables nested within the root table at levels below the root level.

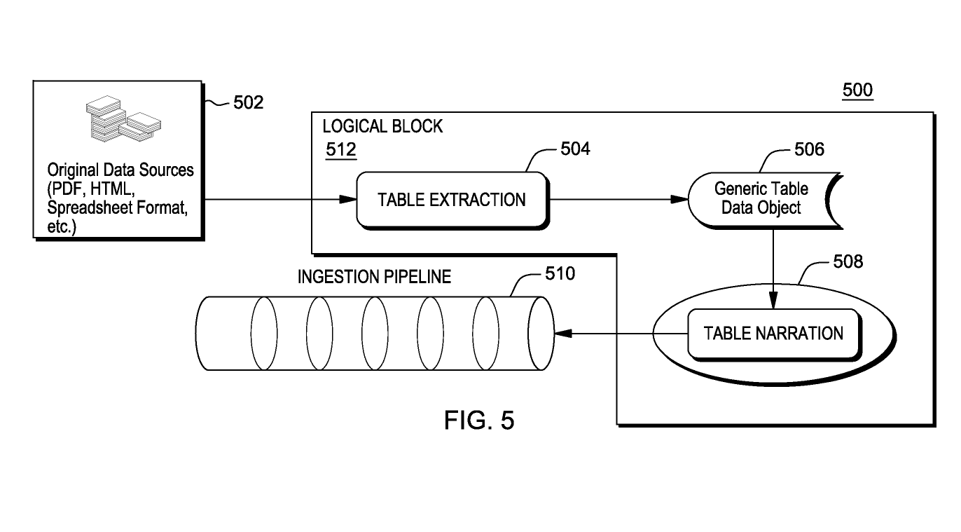

Processing proceeds to step S243, where replacing mod 306 replaces the first nested table with equivalent narration text. This replacement of nested tables with equivalent narration text is shown in a summary fashion in screenshot 400 of FIG. 4, where four nested tables (not shown) nested at the N=2 level in root table 402 have respectively been replaced by narration texts 404, 406, 408, 410.

### III. Further Comments and/or Embodiments

Some embodiments of the present invention eliminate the need for custom programming, based on different table structures and contents, as is generally required by currently conventional technology.

Some embodiments of the present invention may include one, or more, of the following features, characteristics and/or advantages: (i) provides a solution that is flexible and scalable; (ii) provides a solution that minimizes software code changes; (iii) provides a solution that can generalize the detection of nested tables; (iv) provides a solution that can provide narration of nested tables; (v) provides a solution for multiple types of “document source formats” (for example, HTML, PDF, XML, Open Document Format, various commercial and/or proprietary formats, etc.); and/or (vi) provides a solution for all types of “table structures.”

Some embodiments of the present invention further recognize tables may contain other tables, such that the inner table (child table) is completely contained within a cell of an outer table (parent table), where such tables are known as nested tables. Nested tables can go to multiple levels of nesting, that is, an outer parent table may contain one or more child tables, and a child table may contain another child table, and so on. A cell of a parent table may contain more than one child table (that is, two or more child tables may occur within one parent cell) and the same analogy may be extended to any level of nestedness. Nested tables may occur in any format such as HTML (hypertext markup language), PDF (portable document format), ODF (open document format), word processing formats, and/or spreadsheet formats where their detection and extraction may be format specific. Some embodiments of the present invention provide a flexible, scalable approach and algorithm for detection, extraction and narration of nested tables to any level of nestedness. “Table narration,” as used herein, refers to the conversion and description of the contents of a table (semi-structured data) into free form natural language sentences and paragraphs. Some embodiments of the present invention can generate table narration that is equivalent to the original table contents and meaning (herein sometimes referred to as “equivalent table narration”).

Some embodiments of the present invention may further include one, or more, of the following features, characteristics and/or advantages: (i) detection, extraction and narration of nested tables to any level of nestedness is flexible and scalable; (ii) use of recursion for detection, extraction, and narration of nested tables in a generic way (for example, can be used with any kind of table); (iii) does not assume or place any restrictions on the contents of a table; (iv) parent tables and child tables can contain any type of content; (v) able to detect, extract and narrate nested tables to any level of nestedness; (vi) detect, extract, and/or narrate a wide variety of nested tables with different types of structural patterns and content; (vii) existing approaches for format-specific table detection and extraction (such as for PDF and HTML tables) may be used as a part of an overall approach for nested table detection and extraction; (viii) existing approaches for table narration may be used as a part of the overall approach for nested table narration; and/or (ix) the approach gives immense flexibility for nested table detection, extraction, and narration in an ingestion pipeline for use in a question answering system, such as an artificially intelligent computer system.

With regard to the generic approaches repeatedly mentioned above, aspects of the present invention can be used with but are not limited to: (i) tables with different structural patterns; (ii) tables with different cell layouts (for example, Header Cells in a header row or a header column of a table), normal cells (which contain values in a table, and not a header cell), spanned or merged cells (that is, a single cell which may span one or more rows, or one or more columns, or a combination of multiple rows and columns of a table), category cells (special spanned or merged cells which span an entire row or an entire column of a table), etc.; (iii) tables with any type of content (for example, plain text, formatted/rich text, lists (bulleted or numbered lists), URLs, images, charts or graphs, embedded objects such as other files or attachments); (iv) tables with line-based borders; and/or (v) tables without borders.

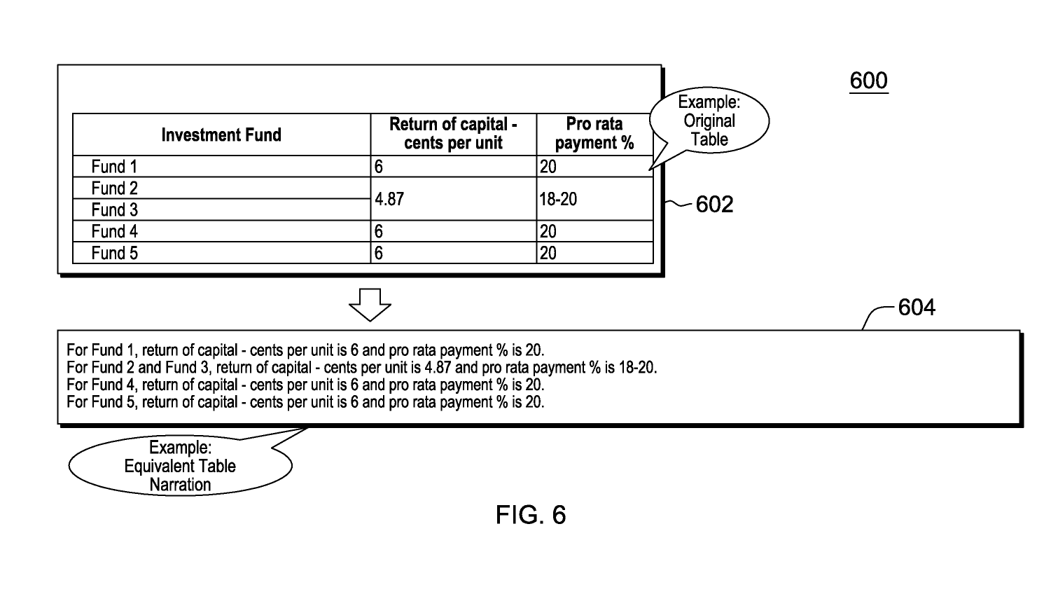

As shown in FIG. 5, system 500 includes: original data sources block 502; logical block 512 (including table extraction block 504, generic table data object block 506 and table narration block 508); and ingestion pipeline block 510. System 500 shows the concept of table narration within the concept and approach for recursive detection, extraction, and narration of nested tables, suitable for use with an embodiment of the present invention. Processing starts by obtaining original source data from original data sources 502 where PDF, HTML, spreadsheet format data, etc. is stored. Then, table extraction block 504 uses its machine logic (for example, software) to perform table extraction on the original source data. Then, generic table data object block 506 is created through the table extraction. Processing continues where machine logic performs table narration within table narration block 508. Finally, the data is fed to ingestion pipeline block 510 where the data is used in question answering systems.

Block 504 is concerned with identifying, detecting and extracting tables from the source documents, and at a conceptual level, this Block 504 is agnostic of the source format. However, at an implementation level, the table extraction process or logic may be format-specific i.e. dependent on the document source format. For example, if the source document is HTML, tables are contained within pre-defined HTML tags <table> . . . </table>, and a parent table may contain nested or child tables through other embedded <table> tags for example: <table> . . This is outer parent table at Level 1 . . . <table> . . . This is child table at Level 2 . . . <table>. . . .This is child table at Level 3 . . . </table> . . . More content in child table at Level 2 . . .</table> . . . More content in parent table at level 1 . . . </table> depicts a parent table containing child tables with three levels of nestedness. Similarly, <table> . . This is outer parent table at Level 1 . . . <table> . . . This is child table 1 at Level 2 . . . </table> . . . . Some more content in parent table at Level 1 . . . <table> . . . This is child table 2 at Level 2 . . . </table> . . . Back to parent table at Level 1 . . . </table> depicts a parent table at Level 1 containing 2 child tables at Level 2 along with other content within the parent table at Level 1. Similarly, tables in PDF documents or Word documents or Spreadsheets or Presentations may be represented in different formats, and the extraction process may be format-specific. However, the table structure or patterns may be common across formats. For example, a parent table at Level 1 with 2 child tables at Level 2 may have identical structural pattern, format and content in HTML, Word and PDF documents.

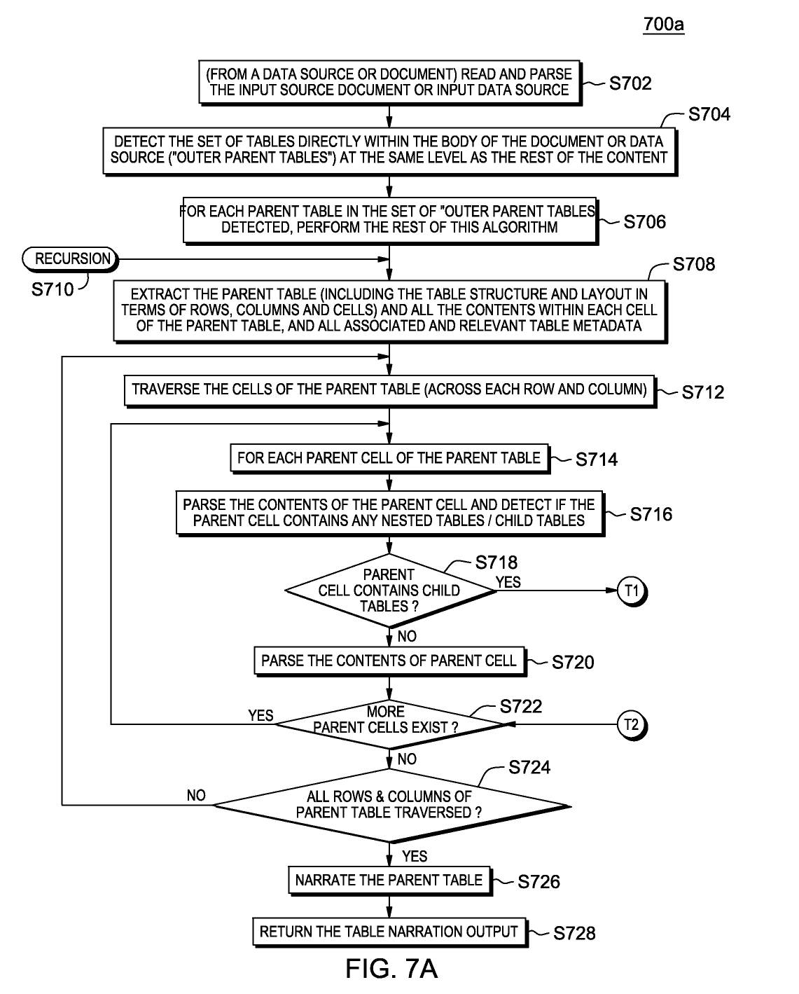

As shown in FIG. 6 screenshot 600, table narration is the conversion and description of the contents of a table (semi-structured data) 602, into free form natural language sentences and paragraph 604, so that the resulting narration is equivalent to the original table contents and meaning.

Some embodiments of the present invention may further include one, or more, of the following features, characteristics and/or advantages: (i) a flexible and scalable approach and algorithm for detection, extraction and narration of nested tables to any level of nestedness; (ii) reading and parsing the input source document (in any supported format such as HTML, PDF, word processing formats, etc.) where parsers used to read and parse the source documents may be format-specific, such as a DOM (document object model) or SAX (simple API (application programming interface) for XML (extensible markup language)) parser for HTML documents, a PDF reader or PDF processor for PDF documents, etc.; and/or (iii) detecting the set of tables directly within the body of the document (“outer tables” or “outer parent table”). This detection step may be format-specific and several different algorithms could be used for actual detection of the source tables.

Further with regard to item (iii) in the above paragraph, other variations (or examples) of format specific detection steps may include but are not limited to those described in the following three (3) paragraphs.

In HTML documents, tables are denoted by and enclosed within <table> . . . </table> tags. The outermost <table> . . . </table> tags which occur directly within the HTML page body (directly within the <body> . . . </body> tags) can be considered as the “outer tables” for the purposes of this step.

In PDF documents, tables either have proper line-based borders (that is, tables with borders) or they may be grids of text without proper line-based borders (that is, tables without borders). There may be different algorithms or tools for detecting and extracting both these types of tables in PDF documents.

In other document formats, for example word processing formats and spreadsheet formats, tables may have format-specific representations, and the specific tools or algorithms for detection of tables may vary.

In some embodiments of the present invention, for each parent table in the set of “outer tables” detected the following algorithm is performed: (i) using recursion, extract the parent table (including the table structure and layout in terms of rows, columns and cells) and all the contents within each cell of the parent table, and all associated and relevant table metadata; and (ii) narrate the parent table. Further with regard to algorithm step (i), the following sub-steps are performed: (a) traverse the cells of the parent table (across each row and column); and (b) perform software recognition for each parent cell of the parent table. Further with regard to algorithm sub-step (b), the software performs the following sub-sub steps: (1) parses the contents of the parent cell and detects if the parent cell contains any nested tables/child tables; (2) determines if the parent cell contains one or more tables; and (3) parses the contents of the parent cell if the parent cell does not contain a table, nested table, or child table. Further with regard to sub-sub-step (1), detecting child tables may be format-specific (for example, in HTML, an outer table may contain a nested child table [table tags in the format <table> . . . <table> . . . </table> . . . </table>] whereas in PDF or word processing formats, different algorithms may be required to detect that the cell of an outer table contains another child table within its boundaries).

An embodiment of a method for parsing the contents of a cell that includes a table (or nested table) is as follows: (i) extract and parse the contents with level one (1) nesting of the parent cell until the first child table within the cell is encountered; (ii) mark the relative positions of the contents with level one (1) nesting (may be text and other contents such as images, etc.) and the first child table within the parent cell; (iii) extract the child table (including the table structure and layout in terms of rows, columns, and cells) and all its table contents and relevant metadata (this is done as a recursive step); (iv) from the output of the recursive step, obtain the equivalent child table narration for the child table; (v) in the parent cell, replace the child table with the equivalent child table narration so that the content of the parent cell now becomes (contents=contents with level one (1) nesting+narrated child table); (vi) continue parsing, extracting and appending the subsequent contents of the parent cell until another child table is encountered; and (vii) move to the next parent cell of the parent table if the contents of the parent cell are completely parsed and all child tables are narrated.

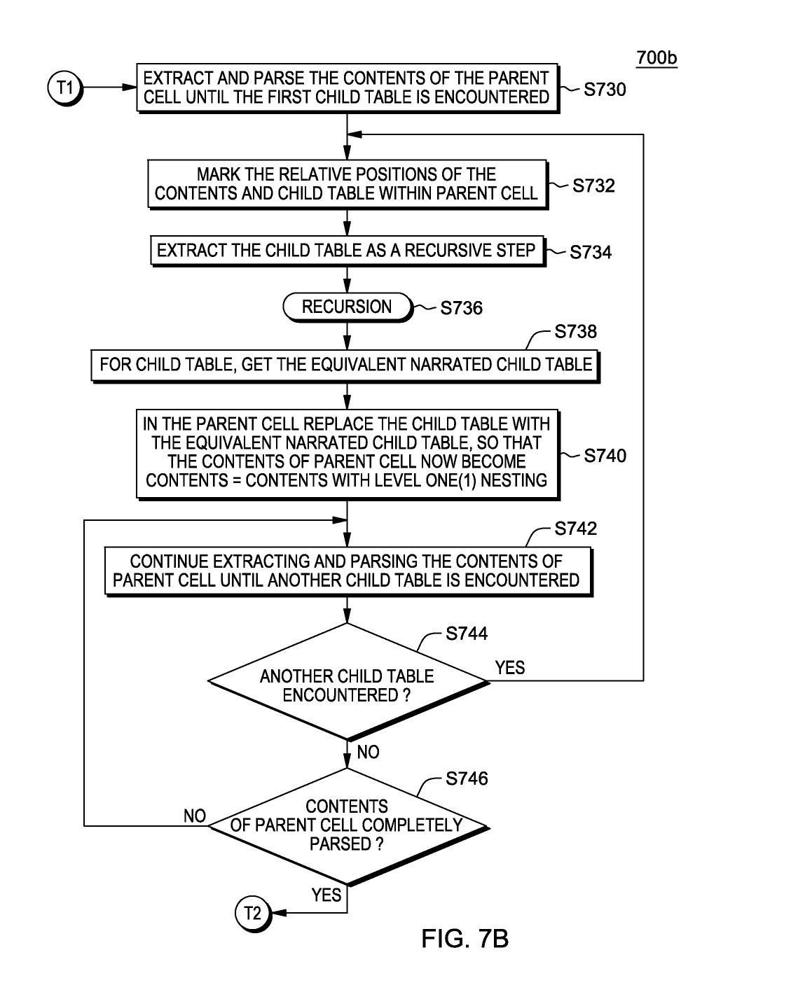

As shown in FIGS. 7A and 7B, flowcharts 700a and 700b respectively, describe the method of recursive extraction and narration of nested tables into natural language sentences and paragraphs. Some embodiments of the present invention further recognize the resulting narration is equivalent to the original table contents and meaning. The respective flowchart portions 700a, 700b are connected through terminals T1 and T2 as shown in FIGS. 7A and 7B.

Processing begins at step S702, where block 504 (see FIG. 5) reads and parses the original data sources block 502 (see FIG. 5) containing the input source document or input data source.

Processing continues to step S704, where block 504 (see FIG. 5) detects the set of tables directly within the body of the document or data source (“outer parent tables”) at the same level as the rest of the content.

Processing continues to step S706, where the software performs the algorithm steps herein for each parent table in the set of “outer parent tables” (also called “root tables” or “tables at first level of nestedness”) detected at step S704. This “looping” for processing each outer table (or, “each table at first level of nestedness”) is indicated by recursion step S710.

Processing continues to step S708, where blocks 504 and/or 506 (see FIG. 5) extract: (i) the parent table (including the table structure and layout in terms of rows, columns, and cells); (ii) all the contents within each cell of the parent table; and (iii) all associated and relevant table metadata.

Processing continues to step S712, where block 504 extracts the entire table. In, FIG. 5, logical block 512, which encompasses blocks 504, 506 and 508, and in addition block 512 may perform the additional logic or steps outlined in FIGS. 7A and 7B. Block 512 is depicted as surrounding the blocks 504, 506 and 508). Step S712 traverses the cells of the parent table (across each row and column).

Processing continues to step S714, indicates that a loop is performed to step through each parent cell of the parent table.

Processing proceeds to step S716, where the logical block 512 parses the contents of the parent cell and detect if the parent cell contains any nested tables or child tables.

Processing continues to step S718, where logical block 512 determines if parent cell contains any child tables. If yes, processing moves to terminal T1 of method 700b (which will be described in a following paragraph). If no, processing continues to step S720.

At step S720, logical block 512 parses the contents of the parent cell.

Processing proceeds to step S722, where the software determines if additional parent cells are in the parent table. If yes, processing loops back to step S714, where processing continues. If no, processing continues to step S724.

At step S724, logical block 512 determines if all the rows and columns of parent table have been traversed. If no, processing loops back to step S712 where processing continues. If yes, processing continues to step S726.

At step S726, block 508 narrates the parent table.

Processing continues to step S728, where the software returns the table narration output and processing concludes.

As described above, at step S718 processing conditionally proceeds to terminal T1 (see FIG. 7A and 7B). Processing that proceeds from terminal T1 will now be discussed with reference to flowchart 700b of FIG. 7B.

Processing proceeds to step S730, where the software will extract and parse the contents with level one (1) nesting of parent cell until the first child table is encountered. Processing continues to step S732 where the software marks the relative positions of the contents with level one (1) nesting and child table within parent cell. Processing continues to step S734 where the software extracts the child table using software recursion, step S736. Steps S738 and S710 are equivalent and refer to the same recursion process. Processing continues to step S738 where the software obtains the equivalent narrated child table. Processing continues to step S740 where the software replaces child table with the equivalent narrated child table in parent cell. The content of the parent cell now becomes (contents=contents with level (1) nesting+narrated child table). Processing continues to step S742 where the software continues extracting and parsing the contents of the parent cell until another child table is encountered. Processing continues to step S744 where the software determines if another child table is encountered. If yes, processing loops back to step S732 where processing continues. If no, processing continues to step S746 where the software determines if the contents of parent cell are completely parsed. If no, processing loops back to step S742. If yes, processing moves to terminal T2 of method 700a, and loops back to step S722 where processing continues.

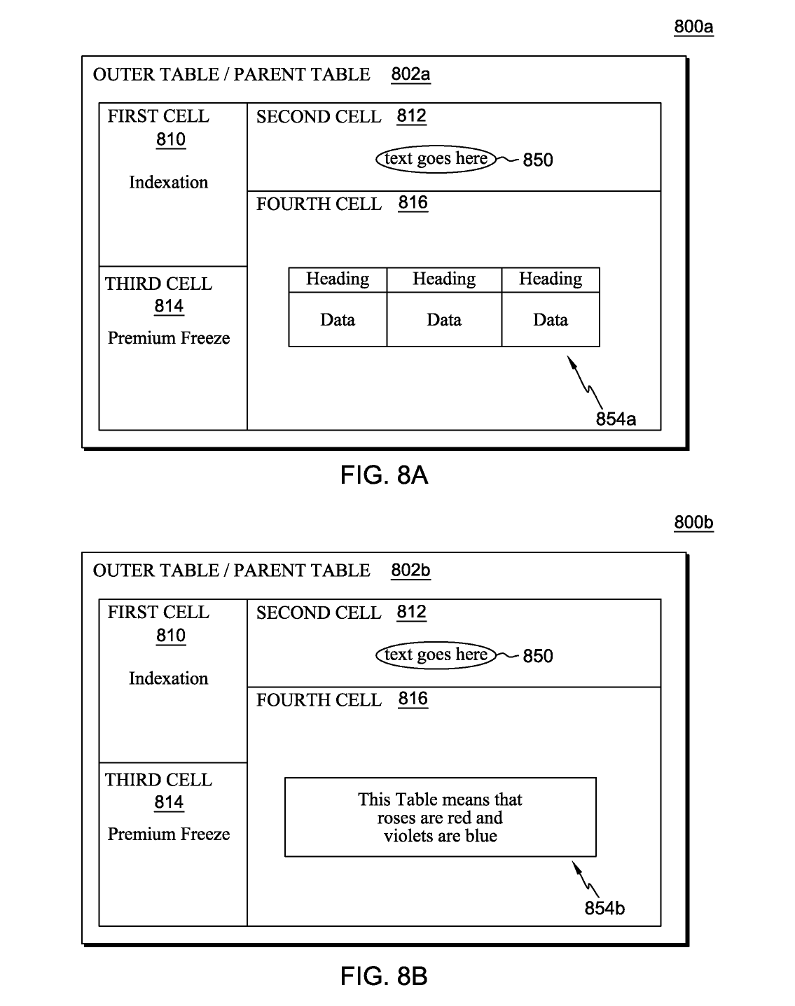

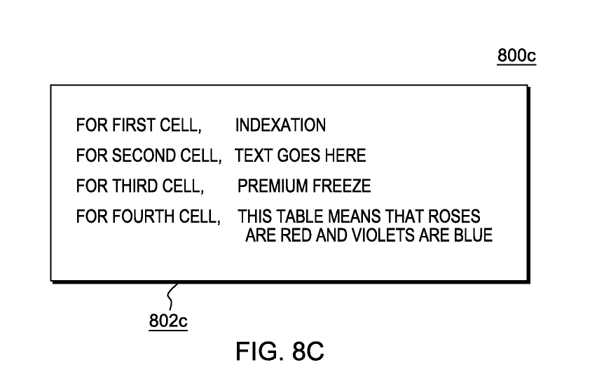

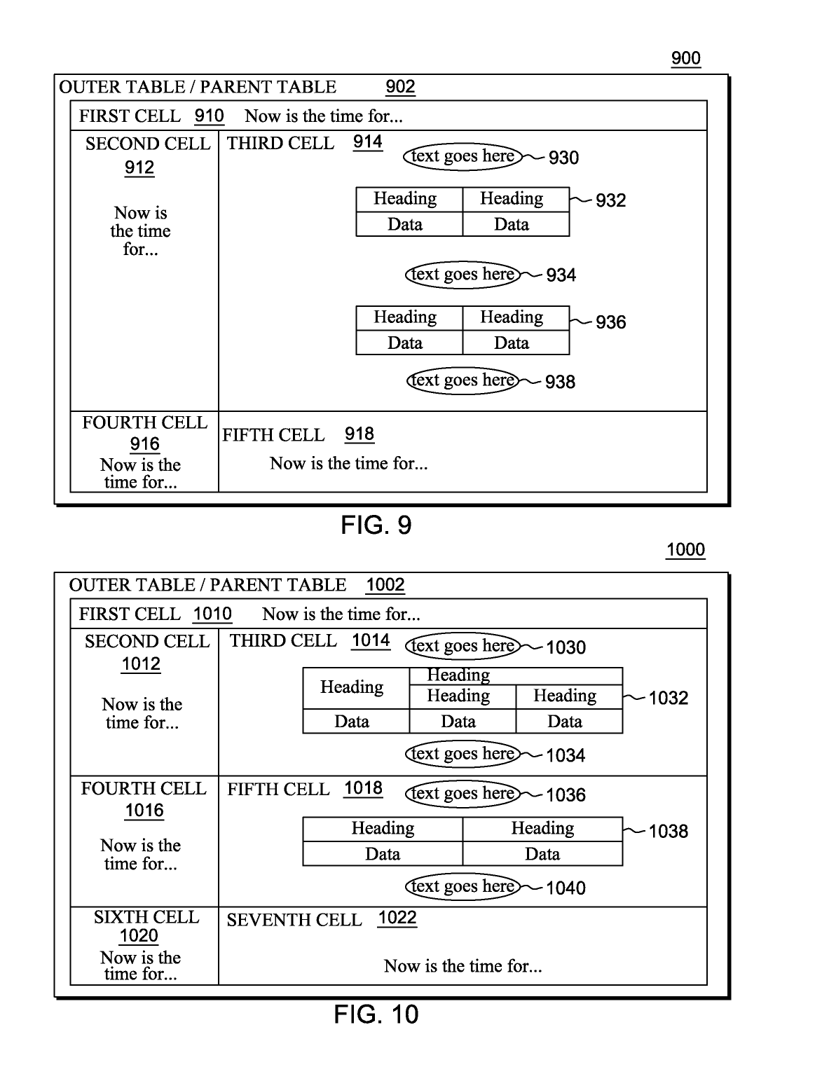

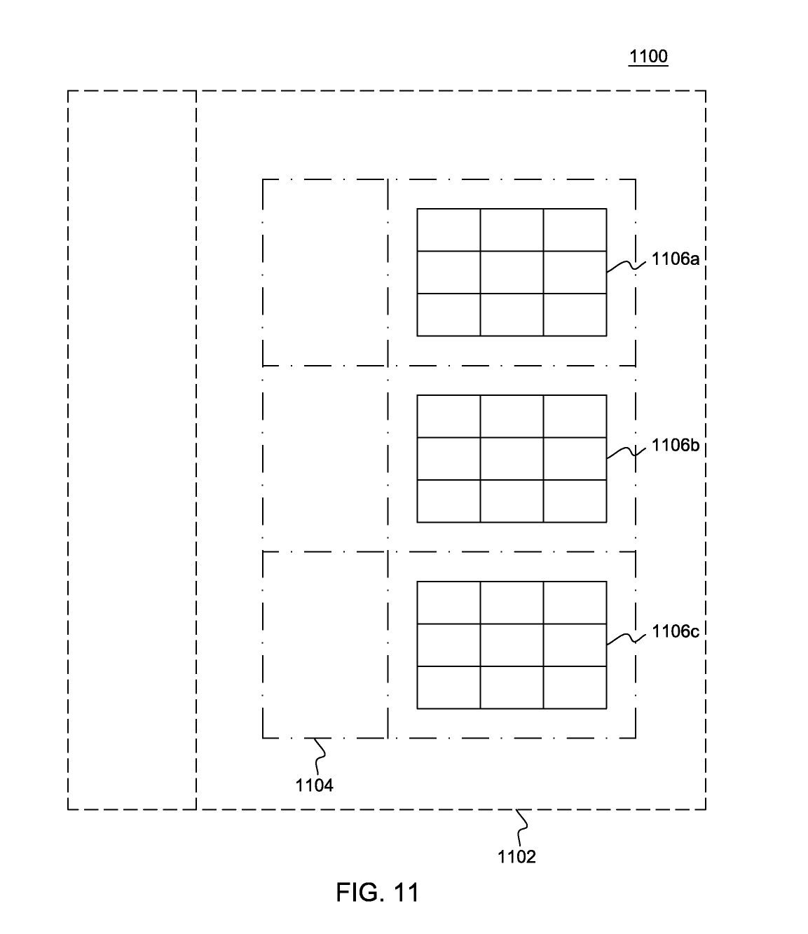

There are several different types of nested tables to which various embodiments of the present invention may be applied, including but not limited to the following: (i) outer table/parent table with one (1) child table as shown in FIGS. 8A to 8C; (ii) outer table/parent table with two (2) child tables in the same cell as shown in FIG. 9; (iii) outer table/parent table with two (2) child tables in different cells as shown in FIG. 10; and/or (iv) outer table/parent table with one (1) child table (level 2 nesting), and the level 2 child table containing two (2) child tables (level 3 nesting) in different cells as shown in FIG. 11. Examples of outer table/parent table detection, extraction, and narration by the software algorithm, are illustrated in FIGS. 8A to 11 and described below. Herein, when describing FIGS. 8A to 11: (i) “outer table/parent table” will be described as “parent table;” and (ii) the parent table will be considered to be at the first level of nestedness (also sometimes herein referred to as Level 1).

As shown in FIG. 8A to 8C, screenshots 800a to 800c show various portions of a nested table 802a, b, c. This nested table may also be called the parent table, or the outer table or the Level 1 table. Nested table 802 includes four cells 810, 812, 814, 816 at the first (or outermost) level of nestedness. Each of the cells includes data. For example, second cell 812 includes text data 850. More importantly for present purposes, fourth cell 816 includes child table 854a, b, which child table is at the second level of nestedness (that is, Level 2). In screenshot 800a of FIG. 8A, table 854 is shown to the user, through a display, as a table. However, after table 854 is extracted and narrated, according to the present invention, it is shown in the form of table narration 854b (see FIG. 8B). In other words, as the recursive narration is in process as shown in FIG. 8B, Level 2 table 854 is extracted and narrated, but, Level 1 table 802 has not yet been extracted and narrated. Moving from screenshot 800b of FIG. 8B to screenshot 800c of FIG. 8C, Level 1 table 802 is now shown in narrated form as reference numeral 802c. Now that the recursion has reached up all the way to Level 1, all of the extraction and narration has been completed.

As shown in FIG. 9, screenshot 900 is an example of a “parent table with two (2) child tables in the same cell” which includes the following: outer table/parent table (with level one (1) nesting) 902; first cell 910; second cell 912; third cell 914; fourth cell 916; fifth cell 918; textual content (third cell with level one (1) nesting) 930; child table 1 (with level two (2) nesting) 932; textual content (third cell with level one (1) nesting) 934; child table 2 (with level two (2) nesting) 936; textual content (third cell with level one (1) nesting) 938.

Processing begins where the software detects parent table 902 and then extracts parent table 902. The software traverses first cell 910, second cell 912, third cell 914, fourth cell 916 and fifth cell 918 of parent table 902. For first cell 910 and second cell 912, no child tables are detected by the software and contents are parsed “as-is.” Processing continues where third cell 914, child table 932 and child table 936 are detected by the software. Textual contents 930 of third cell 914 are parsed until child table 932 is encountered. Processing continues where child table 932 is extracted and narrated by the software recursive step (not shown), and the equivalent child table narration (narrated child table with level one (1) nesting) (not shown) is obtained. Child table 932 at level two (2) nesting is replaced by narrated child table with level one (1) nesting in the third cell 914 of parent table 902. The textual content of the third cell 914 of parent table 902 thus becomes (textual content 930+narrated child table with level one (1) nesting). The software continues parsing textual content 934 of third cell 914 of parent table 902 until child table 936 is encountered. Child table 936 is extracted and narrated by the software recursive step, and the equivalent narrated child table with level one (1) nesting is obtained. Child table 936 at level two (2) nesting is replaced by narrated child table with level one (1) nesting in the third cell 914 of parent table 902. The contents of third cell 914 of parent table 902 thus becomes (textual content 930+narrated child table with level one (1) nesting+textual content 934+narrated child table with level one (1) nesting). The software continues parsing the contents of textual content 938 of third cell 914, and the final contents of the third cell 914 of parent table 902 becomes (textual content 930+narrated child table with level one (1) nesting+textual content 934+narrated child table with level one (1) nesting+textual content 938). For fourth cell 916 and fifth cell 918 of parent table 902, no child tables are detected by the software and the contents are parsed “as-is.” Processing concludes where parent table 902 is narrated to produce equivalent narrated parent table with level one (1) nesting. Thus, a parent table 902 with two (2) child tables, 932 and 936 in the same cell, can be detected, extracted, and narrated by the algorithm.

As shown in FIG. 10, screenshot 1000 is an example of a “parent table with two child tables in different cells” which includes the following: outer table/parent table (with level one (1) nesting) 1002; first cell 1010; second cell 1012; third cell 1014; fourth cell 1016; fifth cell 1018; sixth cell 1020; seventh cell 1022; textual content (third cell with level one (1) nesting) 1030; child table (with level two (2) nesting) 1032; textual content (third cell with level one (1) nesting) 1034; textual content (fifth cell with level one (1) nesting) 1036; child table (with level two (2) nesting) 1038; and textual content (fifth cell with level one (1) nesting) 1040.

Processing begins where the software detects parent table 1002 and then extracts parent table 1002. The software then traverses cell first cell 1010, second cell 1012, third cell 1014, fourth cell 1016, fifth cell 1018, sixth cell 1020, and seventh cell 1022 of parent table 1002. For first cell 1010 and second cell 1012, no child tables are detected by the software and the contents are parsed “as-is.” For third cell 1014, one child table 1032 is detected by the software. The textual contents 1030 of the third cell 1014 are parsed until child table 1032 is encountered. Child table 1032 at level two (2) nesting is extracted and narrated by the software recursive step (not shown), and the equivalent narrated child table with level one (1) nesting (not shown) is obtained. Child table 1032 is replaced by narrated child table with level one (1) nesting in the third cell 1014 of parent table 1002. The content of third cell 1014 of parent table 1002 thus becomes (textual content 1030+narrated child table with level one (1) nesting).

Parsing of textual contents 1034 of the third cell 1014 of parent table 1002 is continued by the software, and the final contents of the third cell 1014 becomes (textual content 1030+narrated child table with level one (1) nesting+textual content 1034). For fourth cell 1016, no child tables are detected and contents parsed “as-is”. For fifth cell 1018, one child table 1038 is detected. The textual contents 1036 of fifth cell 1018 are parsed until child table 1038 is encountered. Processing continues where child table 1038 at level two (2) nesting is extracted and narrated by the software recursive step, and the equivalent narrated child table with level one (1) nesting (not shown) is obtained. Child table 1038 is replaced by narrated child table with level one (1) nesting in fifth cell 1018 of parent table 1002. The content of fifth cell 1018 thus becomes (textual content 1036+narrated child table with level one (1) nesting). Parsing of textual content 1040 of fifth cell 1018 continues by the software, and the final contents of the fifth cell 1018 are (textual content 1036+narrated child table with level one (1) nesting+textual content 1040). For sixth cell 1020 and seventh cell 1022 of parent table 1002, no child tables are detected and the contents are parsed “as-is”. Processing concludes where parent table 1002 is narrated to produce equivalent narrated parent table with level one (1) nesting (not shown). Thus, a parent table 1002 with two (2) child tables, 1032 and 1038 in different cells can be detected, extracted and narrated recursively by the algorithm.

As shown in FIG. 11, screenshot 1100 shows nested table 1102 (shown in dashed lines), which includes: Level 2 table 1104 (shown in dot-dash line); first Level 3 table 1106a (shown in solid lines); second Level 3 table 1106b (shown in solid lines); and third Level 3 table 1106c (shown in solid lines). According to the present invention, the Level 3 tables are extracted and narrated first. After that, Level 2 table 1104 is extracted and narrated. After that, nested table 1102 (also known as the Level 1 table) is extracted and narrated. Some embodiments of the present invention can recursively extract and narrate at even more than three levels. Some embodiments of the present invention can extract and narrate up to an extremely high number of levels (limited only by factors like the abilities of a processor or the amount of system memory).

Some embodiments of the present invention may further include one, or more, of the following features, characteristics and/or advantages: (i) an approach for the simultaneous detection, extraction and narration of nested tables in a recursive manner, to any level of nestedness; (ii) detecting borderless tables; (iii) recursively detecting and extracting nested tables from any kind of document; (iv) deals with all types of tables with or without borders; and/or (v) deals with a wide variety of document formats.

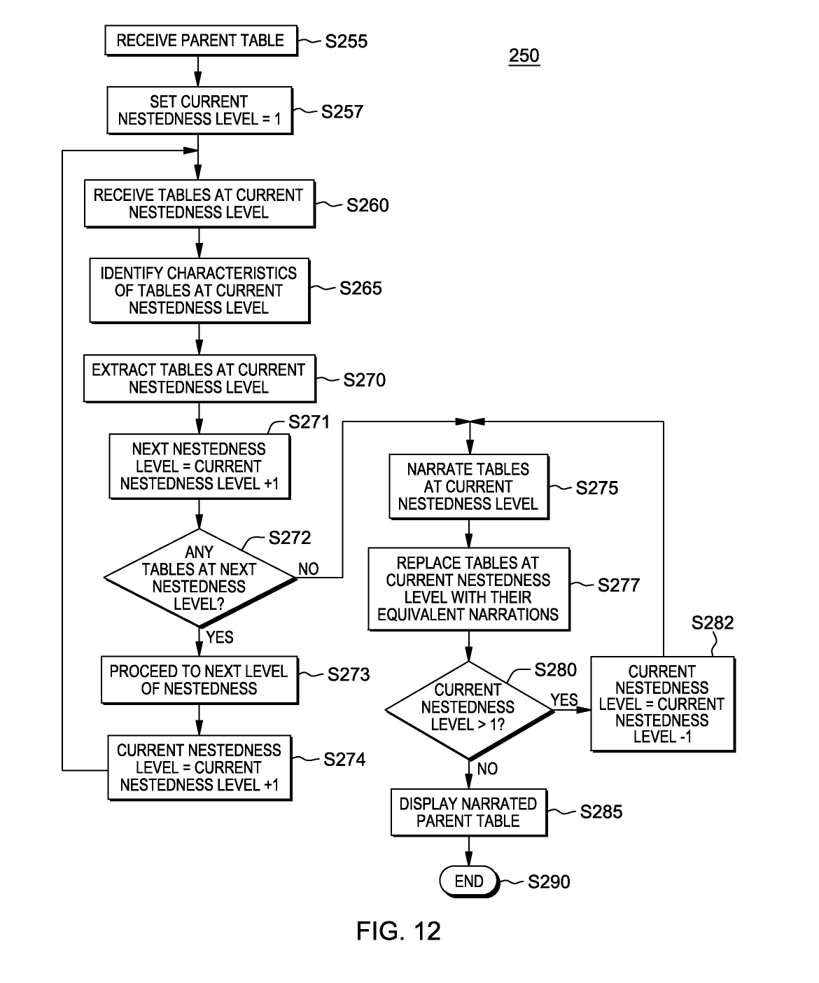

FIG. 12 shows flow chart 250 according to the present invention. Flow chart 250 corresponds to a method including the following steps (with process flow among and between the steps as shown in flow chart 250): S255; S257; S260; S265; S270; S271; S272; S273; S274; S275; S277; S280; S282; S285; and S290. The method of flow chart 250 includes incrementing current nestedness level (CL) in one loop as tables are recursively extracted by the algorithm starting with the root table at the first nestedness level till the highest nestedness level is reached, and then decrementing the nestedness level (CL) it another loop where the tables at the highest nestedness level are replaced with the equivalent narrations before the loop proceeds to the previous (next lower) nestedness level. In this embodiment, while the table extraction starts at the 1st level of nestedness and goes down to the Nth level, the table narration actually starts at the Nth level of nestedness, and recursive processing subsequently goes to higher levels, until it reaches Level 1 (that is N=1, which is the outermost parent table (also called root table)). In this embodiment, the logic does not necessarily determine what the value of N is to start with because that does not matter in this particular method. This method actually discovers N through recursion.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1. A method comprising:
providing a set of nested tables;
extracting a first nested table, of the set of nested tables, at the Nth level of nestedness where N is an integer equal to or greater than one, with a value of one representing a root table of the set of nested tables, and with greater values for N representing tables nested within the root table; and
replacing the first nested table with equivalent narration text.

2. The method of claim 1 wherein:
N is greater than one.

3. The method of claim 2 further comprising:
replacing all nested tables at level N with equivalent narration text.

4. The method of claim 1 further comprising:
extracting a second nested table, of the set of nested tables, at the (N−1)th level of nestedness; and
replacing the second nested table with equivalent narration text;
wherein:
the replacement of the second table is performed after the replacement of the first table.

5. The method of claim 1 wherein:
the set of nested tables includes tables having at least two alternative different structural patterns.

6. The method of claim 1 wherein:
the root table is formatted in a first file format; and
the first file format may be one of a plurality of alternative file formats.

7. The method of claim 1 wherein:
the set of nested tables includes tables having two alternative cell layouts.
